(19) United States
(12) Patent Application Publication
(10) Pub. No.: US 2010/0178546 A1
(43) Pub. Date: Jul. 15, 2010

(54) ELECTROCHEMICAL CELL

(75) Inventors: Job Thomas Rijssenbeek, Niskayuna, NY (US); Neil Anthony Johnson, Schenectady, NY (US); Jinghua Liu, Shanghai (CN); Huiqing Wu, Shanghai (CN); Qunjian Huang, Shanghai (CN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/351,123

(22) Filed: Jan. 9, 2009

(51) Int. Cl. H01M 2/14; B44C 1/22; B05D 5/12

(52) U.S. Cl. 429/131; 216/13; 427/115

(57) ABSTRACT

An electrochemical cell is provided that includes a housing that is polygonal in cross-section having a plurality of peripherally spaced corners. The electrochemical cell also includes an ion-conducting separator disposed in the housing. The ion-conducting separator has an anode surface defining a portion of an anode compartment and a cathode surface defining a portion of a cathode compartment. The electrochemical cell also includes an anode current collector system comprising at least one biasing component. The biasing component has a span section, a bias section and an interface section. The bias section is in wicking contact with the anode surface of the separator. The number of biasing components in the anode current collector system differs from the number of the peripherally spaced corners. An energy storage device including a plurality of the electrochemical cells in thermal and/or in electrical communication with each other. A method for forming the biasing component is provided.

### BACKGROUND

1. Technical Field

The invention includes embodiments that relate to an electrochemical cell. The invention includes embodiments that relate to a high temperature rechargeable electrochemical cell. The invention includes embodiments that relate to a method for forming a biasing component for use in the electrochemical cell.

2. Discussion of Related Art

Development work has been undertaken on the anode current collector system that forms the biasing component of rechargeable batteries using sodium for the negative electrodes. The biasing component has at least three functions that are useful for the performance of the battery. One function is to provide intimate and uniform electrical contact between the anode current collector and the ion-conducting separator to facilitate charge transfer in the initial stages of the battery charging when no sodium is present in the anode compartment. A second function is to provide a uniform distribution of metallic sodium over the areas of the separator through which ionic current will be passed. The third function is as a structural support for the separator. It should be noted that the thermal cycling, pressure differential, and vibration in the cell during use may, in some circumstances, damage the separator. A common separator used in these batteries is beta”-alumina solid electrolyte (BASE), a sodium conducting ceramic. Accordingly, a structural support may lend more strength and durability to the BASE.

It may be desirable to have a biasing component for an electrochemical cell that differs from those biasing components that are currently available. It may be desirable to have a method of forming a biasing component that differs from those methods that are currently available.

### BRIEF DESCRIPTION

In one embodiment, an electrochemical cell is provided that includes a housing that is polygonal in cross-section having a plurality of peripherally spaced corners. The electrochemical cell also includes an ion-conducting separator disposed in the housing. The ion-conducting separator has an anode surface defining a portion of an anode compartment and a cathode surface defining a portion of a cathode compartment. The electrochemical cell also includes an anode current collector system comprising at least one biasing component. The biasing component has a span section, a bias section, and an interface section. The bias section is in wicking contact with the anode surface of the separator. The number of biasing components in the anode current collector system differs from the number of the peripherally spaced corners.

In one embodiment, an energy storage device is provided that includes a plurality of the electrochemical cells in thermal and/or electrical communication with each other. The electrochemical cell includes a housing that is polygonal in cross-section having a plurality of peripherally spaced corners. The electrochemical cell also includes an ion-conducting separator disposed in the housing. The ion-conducting separator has an anode surface defining a portion of an anode compartment and a cathode surface defining a portion of a cathode compartment. The electrochemical cell also includes an anode current collector system comprising at least one biasing component. The biasing component has a span section, a bias section, and an interface section. The bias section is in wicking contact with the anode surface of the separator. The number of biasing components in the anode current collector system differs from the number of the peripherally spaced corners.

In one embodiment of the invention, a method for forming a biasing component for use in an electrochemical cell is provided. The electrochemical cell includes a separator and a housing. The separator is rugate and has an anode surface. The housing has a polygonal cross-sectional profile to define a plurality of corners. The method includes adapting an electrically conductive metal sheet into a biasing component having a span section, a bias section, and an interface section.

### BRIEF DESCRIPTION OF DRAWINGS

FIG. 1 is a schematic view illustrating an anode current collector system in accordance with an embodiment of the invention.

FIG. 2 is a schematic view illustrating an anode current collector system in accordance with an embodiment of the invention.

FIG. 3 is a schematic view illustrating a three dimensional view of an anode current collector system in accordance with an embodiment of the invention.

FIG. 4 is a schematic view illustrating a three dimensional view of an anode current collector system in accordance with an embodiment of the invention.

FIG. 5 is a schematic view illustrating an anode current collector system in accordance with an embodiment of the invention.

FIG. 6 is a schematic view illustrating an anode current collector system in accordance with an embodiment of the invention.

FIG. 7 is a pictorial view of a portion of a dismantled sodium-sodium electrochemical cell showing the uniform distribution of sodium under a biasing component of an electrochemical cell in accordance with an embodiment of the invention.

### DETAILED DESCRIPTION

The invention includes embodiments that relate to an electrochemical cell. The invention includes embodiments that relate to a high temperature rechargeable electrochemical cell. The invention includes embodiments that relate to a method for forming a biasing component for use in the electrochemical cell.

As used herein, cathodic material is a material that supplies electrons during charge and is present as part of a redox reaction. Anodic material accepts electrons during charge and is present as part of the redox reaction. Approximating language, as used herein throughout the specification and claims, may be applied to modify any quantitative representation that could permissibly vary without resulting in a change in the basic function to which it may be about related. Accordingly, a value modified by a term such as “about” is not limited to the precise value specified. In some instances, the approximating language may correspond to the precision of an instrument for measuring the value.

In accordance with an embodiment, an electrochemical cell is provided that includes a housing that is polygonal in cross-section and that has a plurality of peripherally spaced corners. The electrochemical cell also includes an ion-conducting separator disposed in the housing. The ion-conducting separator has an anode surface defining a portion of an anode compartment and a cathode surface defining a portion of a cathode compartment. The electrochemical cell also includes an anode current collector system comprising at least one biasing component. The biasing component has a span section, a bias section, and an interface section. The bias section is in wicking contact with the anode surface of the separator. The number of biasing components in the anode current collector system differs from the number of the peripherally spaced corners. Wicking contact indicates positioning that allows for wicking of a fluid for a defined distance within a defined gap under determined operating conditions.

In one embodiment, the housing of the electrochemical cell may have four corners and the anode current collector may have one biasing component. In one embodiment, the housing of the electrochemical cell may have four corners and the anode current collector may have two biasing components. In one embodiment, the housing of the electrochemical cell may have four corners and the anode current collector may have three biasing components.

While the separator can have a circular, an oval or ellipsoidal, or polygonal cross-sectional profile, in some embodiments the separator may have one or more rugates. The rugates, or cloverleaf shape, may increase the overall available surface area of the separator for a given volume. It is possible to have the number of rugates of the separator correspond in number to the plurality of the peripherally spaced corners of the housing. The separator may be concentrically located in the housing, with each rugate of the separator being peripherally aligned with, and projecting towards, one of the peripheral corners of the housing. The span section spans a gap between an inner surface of the housing and the outward-facing surface of the separator. The span section may be disposed between a pair of rugates of the separator. The bias section protrudes from the span section and extends around and engages at least a part of the anode surface of the separator.

In one embodiment, the separator may have four rugates and the current collector system may have one biasing component. In another embodiment, the separator may have four rugates and the current collector system may have two biasing components. In one embodiment, the separator may have four rugates and the current collector system may have three biasing components. Due to the desire to have approximately equal pressure supporting the separator, additional support structures may be employed to further support the separator.

Elaborating on the above disclosure, the separator may be cylindrical, elongate, tubular, or cup-shaped. Further, the separator may have a closed end and an open end. The open-end of the separator may be sealable, and may be part of a separator assembly that defines an aperture filling the separator with material during the manufacture process. In one instance, the aperture may be useful for adding solid granulated cathodic material. The closed-end of the separator may be pre-sealed, to increase the cell integrity and robustness, while not being useful for material additions.

As mentioned above, the biasing component includes a span section, a bias section, and an interface section. The span section can bridge or cover a gap between the inner surface of the housing and the anode surface of the separator. The span section may be disposed between a pair of the separator rugates. The bias section may protrude from the span section, and may extend to engage at least a part of the anode surface of the separator.

In one embodiment, the anode current collector system has a first biasing component comprising a span section, a bias section, and an interface section; and a second biasing component comprising a span section. In one embodiment, the anode current collector system has more than one second biasing component comprising a span section. The portion of the biasing component where the span section may overlap with bias section of the biasing component may be referred to as the interface section of the biasing component. In one embodiment, the interface section is a part of the bias section that is overlapped by the span section of the same biasing component or overlapped by the span section of a second biasing component. In one embodiment, the span section overlaps an interface section of the same biasing component when the number of biasing components is one. In one embodiment, the span section of one biasing component overlaps at least a portion of the interface section of a neighboring biasing component when the number of biasing components is two or more. In one embodiment, the separator has a length and the anode current collector system may extend to the full length of the separator. In one embodiment, the anode current collector system may extend to a part of the length of the separator.

In one embodiment, the biasing component may include a metal sheet. The span portion of the biasing component may be a coil defined by the metal sheet. In one embodiment, the coil may span the space between the interior of the housing and the anode surface of the separator and press the interface section against the anode surface of the separator. In one embodiment, the coil may be configured with a determined number of windings and the coil is formed of a material such that the coil-induced pressure has a determined amount of force. In one embodiment, the coil may include at least one full winding of the metal sheet. In one embodiment, the coil may include from about one to about five full windings of the metal sheet. In one embodiment, the coil may include from about one to about two full windings, from about two to about three full windings, from about three to about four full windings, or from about four to about five full windings of the metal sheet.

In one embodiment, the determined amount of force generated by the coil-induced pressure is configured to achieve a determined distance between the bias section and the anode surface of the separator. The pressure induced by the coil may urge the bias section of the biasing component onto the surface of the separator. In one embodiment, the determined distance between the bias section and the anode surface of the separator has a determined uniformity of gap between the bias section and the anode surface of the separator. In one instance, the gap may be entirely of uniform thickness; while in other embodiments the gap may be configured to be larger or smaller at the top or the bottom of the cell or may be configured to be larger or smaller as a function of circumferential location around the separator. The determined distance between the bias section of the metal sheet and the anode surface of the separator may be greater than about 1 micrometer. In one embodiment, the determined distance may be in a range of from about 1 micrometer to about 10 micrometers, from about 10 micrometers to about 50 micrometers, from about 50 micrometers to about 100 micrometers, from about 100 micrometers to about 250 micrometers, from about 250 micrometers to about 500 micrometers, from about 500 micrometers to about 1 millimeter, or greater than about 1 millimeter. The determined distance between the bias portion and the anode surface of the separator may result in a determined uniformity of gap between the interface section and the anode surface of the separator.

In one embodiment, the biasing component mitigates, reduces, modifies, or eliminates the translation of a vibration received at the housing to the separator. Further, the biasing component may also serve to prevent rapid mixing of the liquid electrolyte and the anodic material in the event of a cracked separator.

The biasing component material may be selected such that it may be chemically and electrochemically inert in the anode environment while still being electrically conductive. A suitable biasing component can be formed from a metal sheet. The material may include a single metal or may be a metal-containing composite or alloy. In one embodiment, the biasing component may include a non-metal substrate covered with a metal layer on one or both sides. In one embodiment, the biasing component may include steel or nickel. The biasing component may have a thickness that is in a range of from about 0.01 millimeters to about 0.1 millimeters, from about 0.1 millimeters to about 0.5 millimeters, from about 0.5 millimeters to about 0.75 millimeters, from about 0.75 millimeters to about 1 millimeter, or greater than about 1 millimeter.

In various embodiments, the housing-facing surface of the biasing component may be sodium-phobic; and the separator-facing surface of the biasing component may be sodium-philic. In one embodiment, the biasing component includes a layer that makes the separator-facing surface wick. The layer may make the separator-facing surface relatively more susceptible to wicking sodium. The layer may include fibers mats, felts, foams, or adhered or sintered particles. The layer may include a metal. In one embodiment, the metal may include a metal oxide, a metal amide, a metal nitrate, a metal halide, or a combination thereof. The metal may be selected from selenium, lead, nickel, iron, steel, and combinations thereof. In one embodiment, the layer may include one or more of carbon, ceramic, or cermet. Suitable carbon particles may be in the form of graphite powder or lamp black. Suitable carbon black may have particle sizes in a range of from about 10 nanometers to about 500 nanometers, from about 500 nanometers to about 1 micrometer, from about 1 micrometer to about 5 micrometers, from about 5 micrometers to about 25 micrometers, from about 25 micrometers to about 100 micrometers, or greater than about 100 micrometers. The layer may include metal oxide treated carbon surfaces such as felts treated with iron, nickel, cobalt, and chromium. In one embodiment, the layer may include a metal foam. In one embodiment, suitable metal foams may have pore sizes in a range of from about 0.01 millimeter (mm) to about 1.0 mm. In one embodiment, suitable metal foams may have pore sizes in a range of from about 0.01 mm to about 0.05 mm, from about 0.1 mm to about 0.25 mm, from about 0.25 mm to about 0.5 mm, from about 0.5 mm to about 0.75 mm, or from about 0.75 mm to about 1 mm. In one embodiment, suitable metal foams may have pore sizes in a range of from about 0.1 mm to about 0.5 mm. In one embodiment, suitable metal foams may have porosities in a range of from about 60 percent to about 99 percent. In one embodiment, suitable metal foams may have porosities in a range of from about 60 percent to about 65 percent, from about 65 percent to about 70 percent, from about 70 percent to about 75 percent, from about 75 percent to about 80 percent, from about 80 percent to about 85 percent, from about 85 percent to about 90 percent, or from about 90 percent to about 99 percent. In one embodiment, suitable metal foams may have porosities in a range of from about 95 percent to about 97 percent. In one embodiment, the layer may include nickel foam.

In one embodiment, the coating may be applied by using a process comprising spray coating, dip coating, plasma spray, or reactive gas exposure. With further regard to the coating, a layer of anodic material wettable particles may be provided on the interface section of the biasing component. Such particles may assist in promoting contact of the anodic material in the anode compartment with the separator by ensuring efficient transport of anodic material and electrons to and from the separator surface.

In one embodiment, the biasing component is subjected to a surface-treatment to render the separator-facing surface wick. In one embodiment, suitable surface-treatments include subjecting the biasing component to chemical etching, physical etching, or reactive gas exposure. In certain embodiments, the separator-facing surface of the biasing component is patterned. In one embodiment, the patterned surface provides increased surface area. In one embodiment, the patterns may include dimples, slots, grooves, or ridges. The grooves and the ridges may be formed by etching or scarification. The patterned interface section may provide one or more of a relatively increased surface area, anchor points for the coating or mat, and wicking support for the fluid.

The coating or patterning on the separator-facing surface of the bias section of the biasing component then augments the wicking capability of the anodic material wettable particles. The anodic material wettable particles may be electronically or ionically conducting so that they need not be primed with anodic material. In one embodiment, the diameters of the particles may be as small as possible since this enhances their wicking capability. The anodic material wettable particles may be fixed on the anode surface of the separator. In one embodiment, the anodic material wettable particles may be embedded in a non-crystalline layer bonded to the separator. In one embodiment, where the anodic material is sodium, the non-crystalline layer may be composed of a water soluble glass, as sodium silicate, sodium polyphosphate, boric acid, or the like. In one embodiment, the glass layer may be composed of sodium polyphosphate in view of its high degree of water solubility which may enhance its distribution on the separator, and its relatively low dehydration temperature, which promotes the formation of a layer or coat of the sodium polyphosphate on the separator.

In one embodiment, the particles may be fixed to the separator surface by dissolving the water soluble glass in water, admixing the anodic material wettable particles with the glass/water solution so that the anodic material wettable particles get suspended to form a composition, coating the separator with the composition, and drying the coat to form the glass layer or coat on the separator surface. The proportion of anodic material wettable particles to glass may contain sufficient glass to give adequate adhesion to the separator, and sufficient anodic material wettable particles to give adequate wicking, and electronic and/or ionic conductivity.

In one embodiment, the separator may have a top and a bottom during use, and an edge of the biasing component proximate to the separator bottom may be ridged, crenellated or non-linear along at least a portion of its bottom-most length to allow liquid anodic material to flow to and from the anode surface of the separator. The biasing component edge proximate to the separator bottom may have a bevel, chamfer or flange to facilitate insertion of the biasing component and separator assembly into the housing during assembly.

In one embodiment, the biasing component may be perforated in determined locations. In one embodiment, the perforation locations correspond to a height at which a column of anodic material fills an anodic compartment, wherein the anodic compartment may be a volume defined by the anode surface of the separator and an inner surface of the housing. In one embodiment, the perforations allow for increased anodic material flow capacity at the height, and the height may be determined by a state of charge of the electrochemical cell, and whereby the anodic material flow capacity can be controlled versus state of charge. In one embodiment, the metal sheet may be designed to contain perforations, slits, folds, wrinkles, or a combination thereof, to aid anodic material wicking and distribution.

In accordance with an embodiment of the invention, an energy storage device includes a plurality of the electrochemical cells in thermal and/or electrical communication with each other. The electrochemical cell includes a housing that is polygonal in cross-section having a plurality of peripherally spaced corners. The electrochemical cell also includes an ion-conducting separator disposed in the housing. The ion-conducting separator has an anode surface defining a portion of an anode compartment and a cathode surface defining a portion of a cathode compartment. The electrochemical cell also includes an anode current collector system comprising at least one biasing component. The biasing component has a span section, a bias section, and an interface section. The bias section is in wicking contact with the anode surface of the separator. The number of biasing components in the anode current collector system differs from the number of the peripherally spaced corners.

In accordance with an embodiment of the invention, a method for forming a biasing component is provided. The biasing component is used in an electrochemical cell. The electrochemical cell includes a separator and a housing. The separator is rugate and has an anode surface. The housing has a polygonal cross-sectional profile to define a plurality of corners. The method includes adapting an electrically conductive metal sheet into a biasing component having a span section, a bias section, and an interface section.

The method for forming a biasing component further can include surface treatment of the biasing component before forming the metal sheet into the biasing component. The surface treatment can include subjecting the biasing component to plasma etching. In one embodiment, the surface treatment includes coating the biasing component. The surface treatment can include subjecting the biasing component to chemical etching. The surface treatment can include roughing or scarifying a surface of the biasing component. The surface treatment can include patterning the biasing component (e.g, with dimples).

The method for forming a biasing component further can include surface treatment of the biasing component after forming the metal sheet into the biasing component. The methods for surface treatment of the biasing component after forming the metal sheet into the biasing component include one or more techniques selected from subjecting the basing component to plasma etching, to chemical etching, to scarifying, to patterning, and to coating. Suitable coatings can include film formation or layering. An example of forming a layered coating includes securing a sheet of foamed carbon to the separator-contacting face of the biasing component. Suitable foamed carbon can be metal coated to facilitate anode (e.g., molten sodium) wicking, and can have a determined pore size and pore structure to control or maximize the wicking. Other layers include felts, fiber mats, particles, and the like. Suitable metal coating can include, for example, selenium, molybdenum, or nickel coating. The thickness and compliability of the sheet can control the thickness of the gap between the biasing component and the separator surface, and can affect wicking and other cell operation parameters.

Adapting refers to the formation of the span section. This can include coiling a portion of a metal sheet. The number of turns, the winding rate, material selection and other parameters can control and affect the coil compliance. These factors can be controlled to determined levels, and thus the pressure exerted on the separator can be controlled as well.

An edge of the biasing component can be worked and/or formed to facilitate loading of the biasing component into the cell, and the working includes flanging or beveling the edge of the biasing component. An edge of the biasing component can be shaped (e.g., crenellated) to define flowpaths and to facilitate flow of anodic material during cell useage. The working can include forming crenels or ridges on the edge of the biasing component. The biasing component can be perforated to allow for increased anodic material flow capacity at a location on the biasing component wherein the placement corresponds to an anodic material height, which corresponds to a state of charge of the electrochemical cell.

The biasing component may function as both the current collector and the support structure in the anode compartment of batteries using sodium as the anodic material and that utilize a sodium-transporting separator. Sodium batteries include sodium metal halide batteries and sodium sulfur batteries. As discussed above the current collector includes at least one biasing component made of a metal sheet that may be shaped to conform to all or part of the anode surface of the beta-alumina solid electrolyte (BASE) separator. In one embodiment, the metal sheet may be further shaped so that one or more locations of the metal sheet forming the biasing component are in contact with the anode side surface of the BASE. As explained above the metallic sheet is designed in a manner that renders the sheet flexible enough to allow the deposition and wicking of metallic sodium between the sheet and the surface of the BASE. Further the biasing component may include one or more spring-like parts, i.e., the coil that forms the span section, which can act as a shock absorber to protect the BASE from damage. In one embodiment, a maximum of about three metal sheets may be combined to cover most of the surface of the BASE from which an ionic current may be collected. Fewer pieces are desirable because of increased simplicity and lower cost. If there is more than one piece, the pieces may be interlocking or overlapping. In one embodiment, the sheet may be physically connected to or be part of the battery housing. Further connections or contacts may be made between the sheet and battery housing using other pieces which may or may not be of the same material or shape.

The size and shape of the biasing component can provide intimate and uniform electrical contact with the separator to facilitate charge transfer in the initial stages of the battery charging when no sodium is present in the anode compartment. This may be achieved by shaping the metal sheet forming the biasing component to closely conform to the anode surface of the separator. Further the biasing component provides a uniform distribution of metallic sodium over the areas of the separator through which the ionic current will be passed. This may be achieved by wicking of the sodium by capillary forces between the metal sheet and the separator's anode surface. Wicking occurs since the space between the metal sheet and the separator may be less than about 1 millimeter. Wicking may also occur because the biasing component may be flexible enough to accept the volume of the inflowing sodium. Further the biasing component functions as a structural support for the separator. Contact may be established between the biasing component and the housing of the battery to provide dimensional stability by restricting the potential movement of the separator within the housing or by absorbing vibration and shock.

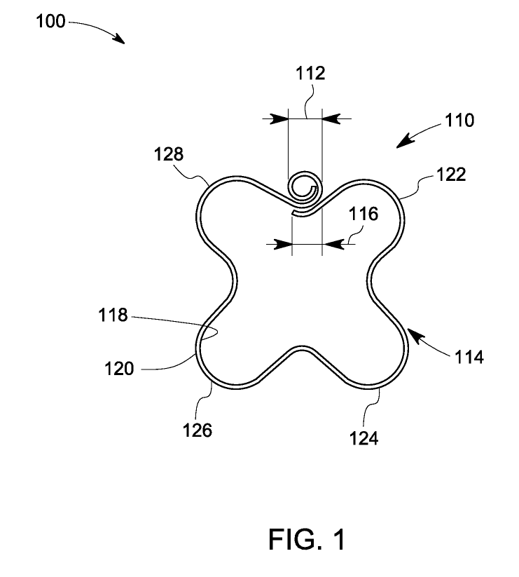

Referring to FIG. 1, an anode current collector system 100 is shown, which includes aspects of the invention. The schematic view includes a top view 110 of a biasing component. The biasing component has a span section 112, a bias section 114 and an interface section 116. The biasing component has an inner surface 118 and an outer surface 120. The inner surface of the biasing component can be mounted in close proximity to an anode surface of a separator (not shown in figure).

In the illustrated embodiment, the separator has four rugates. The outer surface of the biasing component can be mounted in close proximity to an inner surface of a housing (not shown in figure). The span section may be configured to span a gap between an inner surface of the housing and the anode surface of the separator. The bias section protrudes from the span section and extends around and engages at least a part of the anode surface of the separator. The portion of the biasing component where the span section may overlap with bias section of the biasing component forms the interface section of the biasing component. The biasing component has four rugate portions 122, 124, 126 and 128 corresponding to the rugates of the separator. The span section is disposed between a pair of separator rugates. The span section includes one complete winding of the metal sheet forming the biasing component.

Once placed in the housing in this configuration, the interface section of the biasing component is pressed into contact with the span section of the biasing component. The pressure is due to the compression of the coil (forming the span portion) between the separator and the housing. The two ends of the biasing components, the proximate end forming the span section and the distal end forming the interface section, are thus brought in electrical contact with each other.

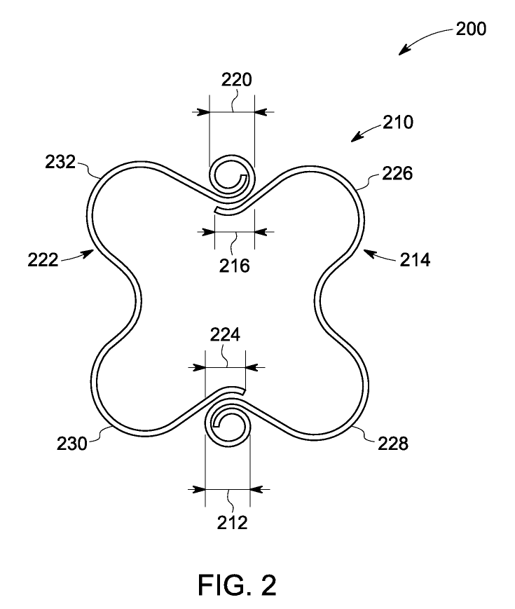

Referring to FIG. 2, an anode current collector system 200 is shown that includes aspects of the invention. The schematic view includes a top view of two biasing components 210 and 218 that together form the anode current collector system. The first biasing component 210 has a span section 212, a bias section 214 and an interface section 216. The second biasing component 218 has a span section 220, a bias section 222 and an interface section 224.

The span section of the first biasing component overlaps the interface section of the second biasing component; and, the span section of the second biasing component overlaps the interface section of the first biasing component. As described in FIG. 1, the span section of the two biasing components spans a gap between the inner surface of the housing (not shown in figure) and the anode surface of the separator (not shown in figure). Conforming to the shape of a separator having four rugates, the first biasing component has two rugate portions 226 and 228 and the second biasing component has two rugate portions 230 and 232. The span section of the first biasing component is disposed between the rugate portions 228 and 230; and, the span section of the second biasing component is disposed between the rugate portions 226 and 232.

Once placed in the housing in this configuration, the interface section of the second biasing component is pressed into contact with the span section of the first biasing component and the interface section of the first biasing component is pressed into contact with the span section of the second biasing component. The pressure is due to the compression of the coil forming the span portion between the separator and the housing. The two biasing components are thus brought in electrical contact with each other.

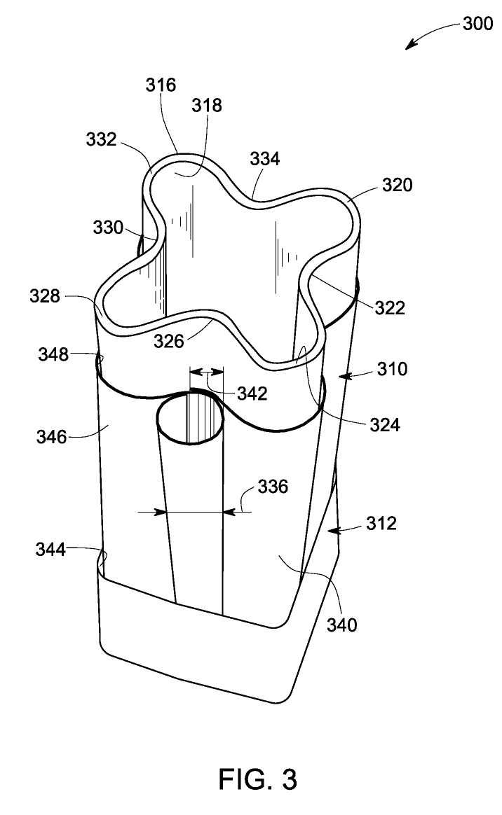

Referring to FIG. 3, a portion of an electrochemical cell 300 is shown that includes aspects of the invention. The figure illustrates a biasing component 310 positioned between a housing 312 and a separator 314. The separator has an anode surface 316 defining a portion of the anode compartment and a cathode surface 318 defining a portion of the cathode compartment. The separator is designed having four rugates forming four convex portions 320, 324, 328 and 332 and four corresponding concave portions 322, 326, 330, and 334.

As shown in the figure, the biasing component has a span section 336, a bias section 340, and an interface section 342. The span section is in the form of a coil and is configured to span a gap between an inner surface of the housing 344 and the anode surface of the separator. Further, the span section is disposed between a pair of the convex portions of the separator rugates 324 and 328 in the concave portion 326. The bias section protrudes from the span section and extends around and engages at least a part of the anode surface of the separator. The bias section is overlapped by the span section at the interface section of the biasing component. The bias section is in wicking contact with the anode surface of the separator.

In this embodiment, the housing has four corners and the current collector system has one biasing component. The biasing component has an outward-facing surface 346 in close proximity to the inward-facing surface of the housing. The biasing component has a separator-facing surface 348 in wicking contact with the anode surface of the separator. The outward-facing surface of the biasing component is plasma-treated to be sodium-phobic. The separator-facing surface of the biasing component is patterned with dimples to increase the surface area, and is then nickel-coated to be sodium-philic. As discussed above, the separator-facing surface of the biasing component may be coated and/or patterned to make the surface sodium-philic or to enhance the sodium-philicity of the separator-facing surface.

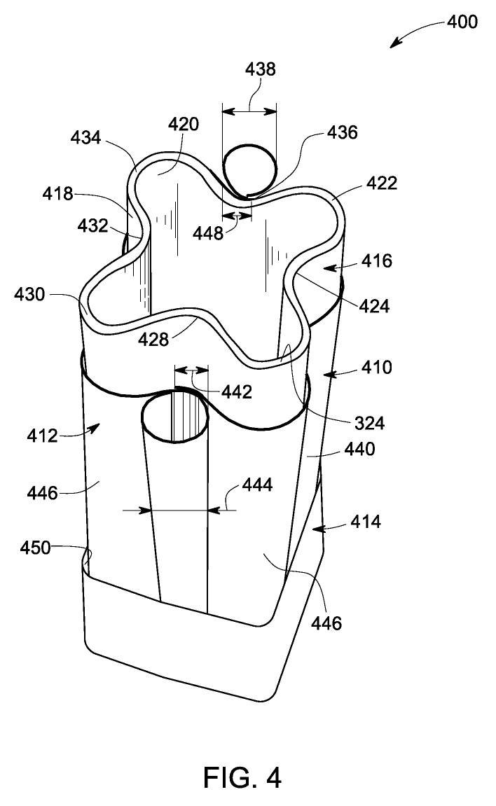

Referring to FIG. 4, a portion of an electrochemical cell 400 is shown that includes aspects of the invention. The figure illustrates two biasing components 410 and 412 positioned between a housing 414 and a separator 416. The separator has an anode surface 418 defining a portion of the anode compartment and a cathode surface 420 defining a portion of the cathode compartment. The separator is designed having four rugates forming four convex portions 422, 426, 430 and 434 and four corresponding concave portions 424, 428, 432, and 436. As shown in the figure, the first biasing component has a span section 438, a bias section 440, and an interface section 442 and the second biasing component has a span section 444, a bias section 446, and an interface section 448. The span sections are in the form of a coil and are configured to span a gap between an inner surface of the housing 450 and the anode surface of the separator.

Further, the span section of the first biasing component is disposed between a pair of the convex portions of the separator rugates 434 and 422 in the concave portion 436. The span section of the second biasing component is disposed between a pair of the convex portions of the separator rugates 430 and 426 in the concave portion 428. The bias sections of the two biasing components protrude from the respective span sections and extend around and engage at least a part of the anode surface of the separator. The bias section of the first biasing component is overlapped by the span section of the second biasing component forming the interface section of the first biasing component. The span section of the first biasing component forming the interface section of the second biasing component overlaps the bias section of the second biasing component. The bias sections are in wicking contact with the anode surface of the separator.

In this embodiment, the housing has four corners and the current collector system has two biasing components. The biasing components have an outward-facing surface (not numbered in figure) in close proximity to the separator-facing surface of the housing. The biasing components have a separator-facing surface (not numbered in FIG. 4) is in wicking contact with the anode surface of the separator. The outward-facing surface of the biasing component is polished to reduce surface area, and then treated to be sodium-phobic. The separator-facing surface of the biasing component is grooved to provide wicking flowpaths, and is layered with metal-coated foam to be sodium-philic.

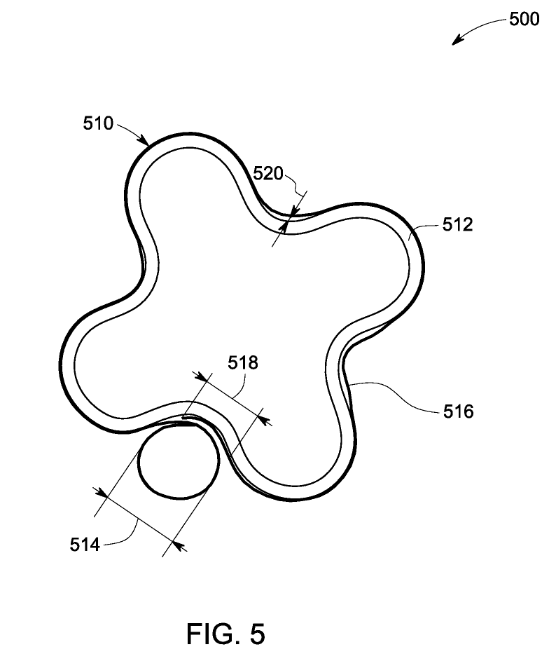

Referring to FIG. 5, an anode current collector system 500 is shown that includes aspects of the invention. The schematic view includes a top view of biasing component 510 engaged around a separator 512. The biasing component has a span section 514, a bias section 516, and an interface section 518. FIG. 5 also shows how the span section of the biasing component forms a coil and is disposed between two rugates of the separator (not numbered in the figure). The figure also shows how the bias section achieves a determined distance 520 between the bias section and the anode surface of the separator. The determined distance affects the wicking rate and volume.

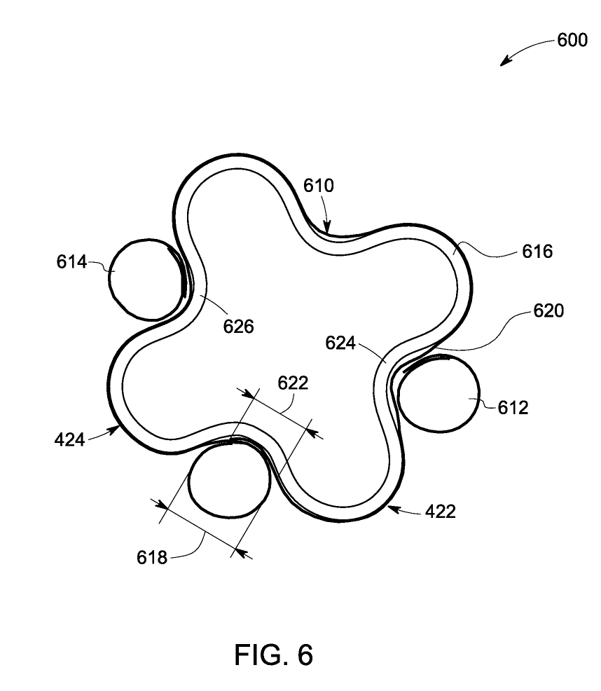

Referring to FIG. 6, an anode current collector system 600 is shown that includes aspects of the invention. The schematic view includes a top view of three biasing components 610, 612, and 614 disposed around a separator 616. The first biasing component has a span section 618 and a bias section 620. The span section of the first biasing component overlaps the distal end of the first biasing component to form a first interface section 622. The second and third biasing components include only a span section that overlaps with the bias section of the first biasing component to form two more interface sections 624 and 626. Once placed in the housing in this configuration, the interface sections of the first biasing component are pressed into contact with the span sections of all three biasing components. The span portion includes the coil. At least some of the pressure is due to the compression of the coil between the separator and the housing. The three biasing components electrically contact each other.

In the drawings, where gaps are shown between the various parts of the biasing components and between the overlapping parts of adjacent biasing components, are for illustration. In practice, these will be in electrical, electronic and/or ionic contact with each other to provide sufficient contact for wicking purposes and electrical communication.

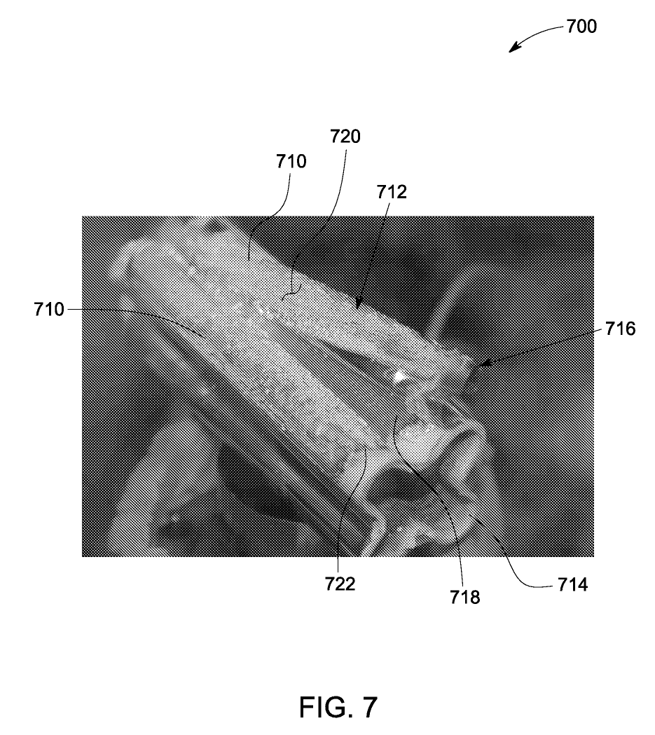

Referring to FIG. 7 a pictorial view of a portion of a dismantled sodium-sodium electrochemical cell 700 shows a uniform distribution of sodium 710 under a biasing component 712. The biasing component is formed from a metal foil. The biasing component was wrapped around the separator 714, but is opened up at the section where the coil 716 overlaps with the interface section 718. The portions have been separated after removal from the housing to allow observation. A layer of sodium is observable on the separator-facing surface 720 of the biasing component and on the anode surface of the separator 722.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, aspects of the invention may include only some of the described embodiments. Accordingly, the invention is not limited by the foregoing description, but is only limited by the scope of the appended claims.

1. An electrochemical cell, comprising:
a housing that is polygonal in cross-section having a plurality of peripherally spaced corners;
an ion-conducting separator disposed in the housing, and having an anode surface defining a portion of an anode compartment and a cathode surface defining a portion of a cathode compartment; and
an anode current collector system comprising at least one biasing component, which has a span section, a bias section, and an interface section, and the bias section is in wicking contact with the anode surface of the separator, and the number of biasing components in the anode current collector system differs from the number of the peripherally spaced corners.

2. The electrochemical cell as defined in claim 1, wherein the housing has four corners and the anode current collector system has one biasing component.

3. The electrochemical cell as defined in claim 1, wherein the housing has four corners and the anode current collector system has two biasing components.

4. The electrochemical cell as defined in claim 1, wherein the separator comprises rugates, and the rugates of the separator correspond in number to the plurality of the peripherally spaced corners of the housing, and the separator is concentrically located in the housing, with each rugate of the separator being peripherally aligned with and projecting towards one of the peripheral corners of the housing.

5. The electrochemical cell as defined in claim 1, wherein the span section is configured to span a gap between an inner surface of the housing and the anode surface of the separator, and the span section is disposed between a pair of rugates of the separator, and the bias section protruding from the span section and extending around and engaging at least a part of the anode surface of the separator.

6. The electrochemical cell as defined in claim 1, wherein the separator has four rugates and the anode current collector system has one biasing component.

7. The electrochemical cell as defined in claim 1, wherein the separator has four rugates and the anode current collector system has two biasing components.

8. The electrochemical cell as defined in claim 1, wherein the separator is cylindrical, elongated, tubular, or cup-shaped, and the separator has a closed end and an open end.

9. The electrochemical cell as defined in claim 1, wherein the anode current collector system has a first biasing component comprising a span section, a bias section, and an interface section; and a second biasing component comprising a span section.

10. The electrochemical cell as defined in claim 8, wherein the anode current collector system has more than one second biasing component comprising a span section.

11. The electrochemical cell as defined in claim 1, wherein the interface section is a part of the bias section that is overlapped by the span section of the same biasing component or overlapped by the span section of a second biasing component.

12. The electrochemical cell as defined in claim 11, wherein the span section overlaps an interface section of the same biasing component when the number of biasing components is one.

13. The electrochemical cell as defined in claim 11, wherein the span section overlaps at least a portion of the interface section of a neighboring biasing component when the number of biasing components is two, or greater than two.

14. The electrochemical cell as defined in claim 1, wherein the separator has a length and the anode current collector system extends to the full length of the separator.

15. The electrochemical cell as defined in claim 1, wherein the biasing component comprises a metal sheet, and the span section comprises a coil defined by the metal sheet, and the coil presses the bias portion against the anode surface of the separator.

16. The electrochemical cell as defined in claim 15, wherein the coil is configured with a determined number of windings and is formed of a material such that the coil-induced pressure has a determined amount of force.

17. The electrochemical cell as defined in claim 15, wherein the coil comprises at least one full winding of the metal sheet.

18. The electrochemical cell as defined in claim 15, wherein the coil is configured to achieve a determined distance between the bias section and the anode surface of the separator.

19. The electrochemical cell as defined in claim 18, wherein the determined distance between the bias section and the anode surface of the separator has a determined uniformity of gap between the bias section and the anode surface of the separator.

20. The electrochemical cell as defined in claim 19, wherein the gap between the bias section and the anode surface of the separator is in a range of from about 10 micrometers to about 1 millimeter.

21. The electrochemical cell as defined in claim 1, wherein the biasing component mitigates, reduces, modifies, or eliminates the translation of a vibration received at the housing to the separator.

22. The electrochemical cell as defined in claim 1, wherein a housing-facing surface of the biasing component is sodium-phobic.

23. The electrochemical cell as defined in claim 1, wherein the separator-facing surface of the biasing component is sodium-philic.

24. The electrochemical cell as defined in claim 23, wherein the biasing component comprises a layer that makes the separator-facing surface wick.

25. The electrochemical cell as defined in claim 23, wherein the layer comprises fibers, mats, felts, foams, or a mass of self-adhered or sintered particles.

26. The electrochemical cell as defined in claim 24, wherein the layer comprises metal.

27. The electrochemical cell as defined in claim 26, wherein the metal comprises a metal oxide, metal amide, metal nitrate, or a metal halide.

28. The electrochemical cell as defined in claim 26, wherein the metal comprises selenium, lead, nickel, iron, or an alloy of one or more of the foregoing.

29. The electrochemical cell as defined in claim 24, wherein the coating is the result of an application process, and the application process is selected from the group consisting of spray coating, dip coating, plasma spray, and reactive gas exposure.

30. The electrochemical cell as defined in claim 23, wherein the biasing component includes at least one surface that has been subjected to a surface-treatment capable of rendering the surface-treated surface relatively more able to wick, in volume or rate, than the same surface prior to the surface-treatment.

31. The electrochemical cell as defined in claim 30, wherein the surface treatment includes one or more of chemical etching, physical etching, or reactive gas exposure.

32. The electrochemical cell as defined in claim 1, wherein the separator-facing surface of the biasing component is patterned.

33. The electrochemical cell as defined in claim 32, wherein the patterned surface provides increased surface area relative to the same surface prior to the patterning.

34. The electrochemical cell as defined in claim 1, wherein during use the separator has a top and a bottom, and the biasing component has an edge that is proximate to the separator bottom and the edge is ridged, crenellated or non-linear along at least a portion of its bottom-most length, and thereby to allow fluid anodic material to flow to and from the anode surface of the separator.

35. The electrochemical cell as defined in claim 1, wherein during assembly the separator has a top and a bottom, and the biasing component has an edge of that is configured for use proximate to the separator bottom, and the edge has a bevel or is flanged so as to facilitate insertion of the biasing component into the housing during assembly.

36. The electrochemical cell as defined in claim 1, wherein the biasing component is perforated in determined locations.

37. The electrochemical cell as defined in claim 36, wherein an anodic compartment is a volume defined by the anode surface of the separator and an inner surface of the housing, and the perforation locations correspond to a height at which a column of anodic material fills an anodic compartment at a determined state of charge of the electrochemical cell.

38. The electrochemical cell as defined in claim 36, wherein the perforations allow for increased anodic material flow capacity at the height, and the height is determined by a state of charge of the electrochemical cell, and whereby the anodic material flow capacity can be controlled versus state of charge.

39. An energy storage device comprising: a plurality of the electrochemical cells as defined in claim 1 that are in thermal and electrical communication with each other.

40. A method associated with a production of a biasing component, comprising:
adapting an electrically conductive sheet into a biasing component having:
a span section;
a bias section that is configured to be in wicking contact with a portion of an anode surface area of an ion-conducting separator; and
an interface section.

41. The method as defined in claim 40, further comprising treating a surface of the biasing component before adapting an electrically conductive sheet.

42. The method as defined in claim 41, wherein treating the surface includes subjecting the electrically conductive sheet to chemical etching or plasma etching.

43. The method as defined in claim 41, wherein treating the surface includes coating the electrically conductive sheet.

44. The method as defined in claim 41, wherein treating the surface includes securing a foamed or mesh layer to the electrically conductive sheet.

45. The method as defined in claim 41, wherein treating the surface includes scarifying, perforating, or patterning.

46. The method as defined in claim 40, wherein adapting comprises forming the span section by coiling a portion of the metal sheet.

47. The method as defined in claim 46, wherein forming the span section includes controlling the number of turns, the winding rate, and other parameters to affect the pressure on the separator after assembly into an electrochemical cell.

48. The method as defined in claim 40, further comprising working an edge of the biasing component to facilitate loading of the biasing component into the cell, and the working comprises flanging or beveling the edge of the biasing component.

49. The method as defined in claim 40, further comprising working an edge of the biasing component to facilitate the anodic material flow wherein working comprises forming crenels or ridges on the edge of the biasing component.

50. The method as defined in claim 40, further comprising perforating the biasing component to allow for increased anodic material flow capacity at a location on the biasing component wherein the placement corresponds to a height of the anodic material, which corresponds to a state of charge of the electrochemical cell.
